(19) United States
(12) Patent Application Publication
(10) Pub. No.: US 2014/0369663 A1
(43) Pub. Date: Dec. 18, 2014

(54) MULTIMEDIA PLAYBACK SYSTEM and CONTROL METHOD THEREOF

(71) Applicant: WISTRON CORPORATION, New Taipei City (TW)

(72) Inventors: Chung-Yiu Lin, New Taipei City (TW); Chih-Wen Huang, New Taipei City (TW); Bor-Lun Chang, New Taipei City (TW)

(73) Assignee: WISTRON CORPORATION, New Taipei City (TW)

(21) Appl. No.: 14/024,641

(22) Filed: Sep. 12, 2013

(30) Foreign Application Priority Data
Jun. 13, 2013 (TW) 102120974

(51) Int. Cl. H04N 21/422; H04N 21/4227

(52) U.S. Cl. CPC H04N 21/42204; H04N 21/4227
USPC 386/234

(57) ABSTRACT

A multimedia playback system includes a multimedia device, for generating a control interface according to a request and performing an operation according to a control signal; a server, coupled to the multimedia device for storing the control interface generated by the multimedia device and generating the control signal according to an instruction signal; and a hand-held device, coupled to the server for accessing the control interface stored in the server and generating the instruction signal according to the control interface and an input signal.

### BACKGROUND OF THE INVENTION

1. Field of the Invention

The present disclosure relates to a multimedia playback system and control method thereof, and more particularly, to a multimedia playback system and control method thereof which configures a control interface in a server.

2. Description of the Prior Art

With the development of multimedia technology, a variety of multimedia devices have become ubiquitous in modern society. Consumer multimedia products, such as television (TV) sets, hi-fi equipments, projectors, digital versatile disc players etc. are widely used. To facilitate control of various functions, most multimedia devices include corresponding remote controllers.

When a user intends to command a multimedia device to perform a function via a corresponding remote controller, the user can press a button corresponding to the function on the remote controller, allowing the remote controller to emit wireless control signals carrying specific information corresponding to the function. After receiving the control signal, the multimedia device interprets the specific information and performs the related function accordingly. Touchtone remote controllers are commonly applied in the prior art. When the functions of the multimedia device become numerous and complicated, the number of buttons on the touchtone remoter controller also increases.

When the multimedia device adds functions via updating, the touchtone remote controller cannot add buttons corresponding to the newly added functions. When the user wants to perform the newly added functions of the multimedia device, the user needs to execute complicated operations. The touchtone remote controller also cannot allow the user to modify the layout of the touchtone remote controller according to the habits of the user (e.g. configuring buttons frequently used in an area that is easy to reach), resulting in an inconvenient user experience.

### SUMMARY OF THE INVENTION

In order to resolve the above problem, the present disclosure provides a multi-media playback system and control method thereof which stores the control interface in the server.

An embodiment of the invention discloses a multimedia playback system comprising a multimedia device, for generating a control interface according to a request and performing an operation according to a control signal; a server, coupled to the multimedia device for storing the control interface generated by the multimedia device and generating the control signal according to an instruction signal; and a hand-held device, coupled to the server for accessing the control interface stored in the server and generating the instruction signal according to the control interface and an input signal.

An embodiment of the invention further discloses a multimedia playback system comprising a multimedia device, a server and a hand-held device. A control method for the multimedia playback system comprises: acquiring a control interface from the multimedia device according to a request; storing the control interface in the server; accessing the control interface stored in the sever via the hand-held device, and generating an instruction signal to the server according to the control interface and an input signal; generating a control signal to the multimedia device via the server according to the instruction signal; and performing an operation via the multimedia device according to the control signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a multimedia playback system according to an embodiment of the present invention.

FIG. 2 is a schematic diagram of an operation method of the multimedia playback system shown in FIG. 1.

FIG. 3 is a schematic diagram of another operation method of the multimedia playback system shown in FIG. 1.

FIG. 4 is a schematic diagram of still another operation method of the multimedia playback system shown in FIG. 1.

FIG. 5 is a schematic diagram of a control interface according to an embodiment of the present invention.

FIG. 6 is a flowchart of a control method according to an embodiment of the present invention.

FIG. 7 is a schematic diagram of an operation method of the control method shown in FIG. 6.

### DETAILED DESCRIPTION

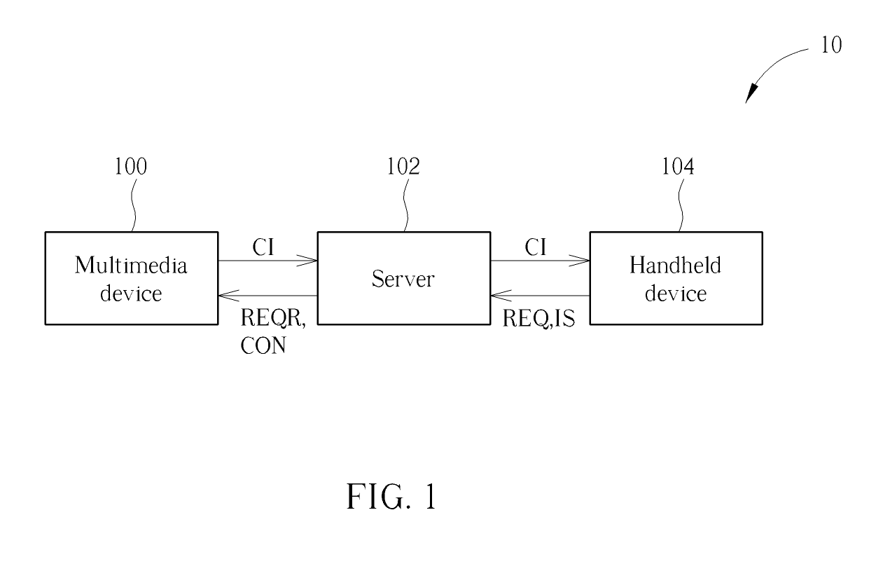

Please refer to FIG. 1, which is a schematic diagram of a multimedia playback system 10 according to an embodiment of the present disclosure. The multimedia playback system 10 provides a convenient user experience and allows a control interface of the multimedia playback system 10 to be adaptively altered according to habits of the user or updates of the multimedia playback system 10. As shown in FIG. 1, the multimedia playback system 10 comprises a multimedia device 100, a server 102 and a handheld device 104. The multimedia device 100 is utilized for performing an operation and generating a control interface CI according to a control signal CON. For example, the multimedia device 100 can be a television, which can perform operations, such as switching channels, adjusting volume and changing an input signal of the multimedia device 100, according to the control signal CON, and is not limited herein. The server 102 is electrically connected to the multimedia device 100 and is utilized for storing the control interface CI outputted by the multimedia device 100 and generating the control signal CON according to an instruction signal IS. The handheld device 104 is electrically connected to the server 102 and is utilized for accessing and displaying the control interface CI, to allow the user to generate the instruction signal IS according to the control interface CI. For example, the handheld device 104 can be a handheld electronic device such as a smart phone and a tablet. Since the control interface CI utilized for controlling the multimedia device 100 is stored in the server 102, the user can alter a layout of the control interface CI according to the habits of the user. When the multimedia device 100 adds new functions via updating, the multimedia device 100 can add buttons corresponding to the new functions in the control interface CI, for allowing the user to perform the new functions of the multimedia device 100 easily. In short, the user can adjust the control interface CI of the multimedia device 100 randomly, and the new buttons can be adaptively added in the control interface CI according to the functions of the multimedia device 100. The user can thereby acquire a more convenient user experience.

In detail, the control interface CI can be a webpage constructed by web languages, such as HyperText Markup Language 5 (HTML 5). When the user wants to control the multimedia device 100 via the handheld device 104, the user can send a request REQ to the server 102 via the handheld device 104. For example, the handheld device 104 can use a network protocol (such as the HyperText Transfer Protocol, HTTP) to send the request REQ to the server 102 via a browser. When the server 102 receives the request REQ transmitted by the handheld device 104, the server 102 analyzes the requests REQ and transmits an analysis result REQR to the multimedia device 100. The multimedia device 100 generates the control interface CI according to the analysis result REQR to the server 102. The control interface CI may comprise a plurality of buttons (e.g. a plurality of buttons corresponding to those of the conventional touchtone remote controller) corresponding to a plurality of functions of the multimedia device 100. Except for storing the control interface CI, the server 102 transmits the control interface CI to the handheld device 104 according to the network protocol. As a result, the user can generate the instruction signal IS via selecting the plurality of buttons displayed by the handheld device 104. After the server 102 analyzes the instruction signal IS, the server 102 generates the corresponding control signal CON to the multimedia device 100, for controlling the multimedia device 100 to perform a corresponding function.

Please note that, no matter which operating system the handheld device 104 is realized in (e.g. Linux, iOS, Android or Windows), since the control interface CI is stored in the server 102 as a webpage in this embodiment, the user can control the multimedia device 100 via the handheld device 104 as long as the handheld device 104 can access the control interface CI according to the network protocol. In other words, when the operating system of the handheld device 104 changes, the control interface CI does not need to be altered. The design cost of the multimedia playback system 10 can therefore be decreased.

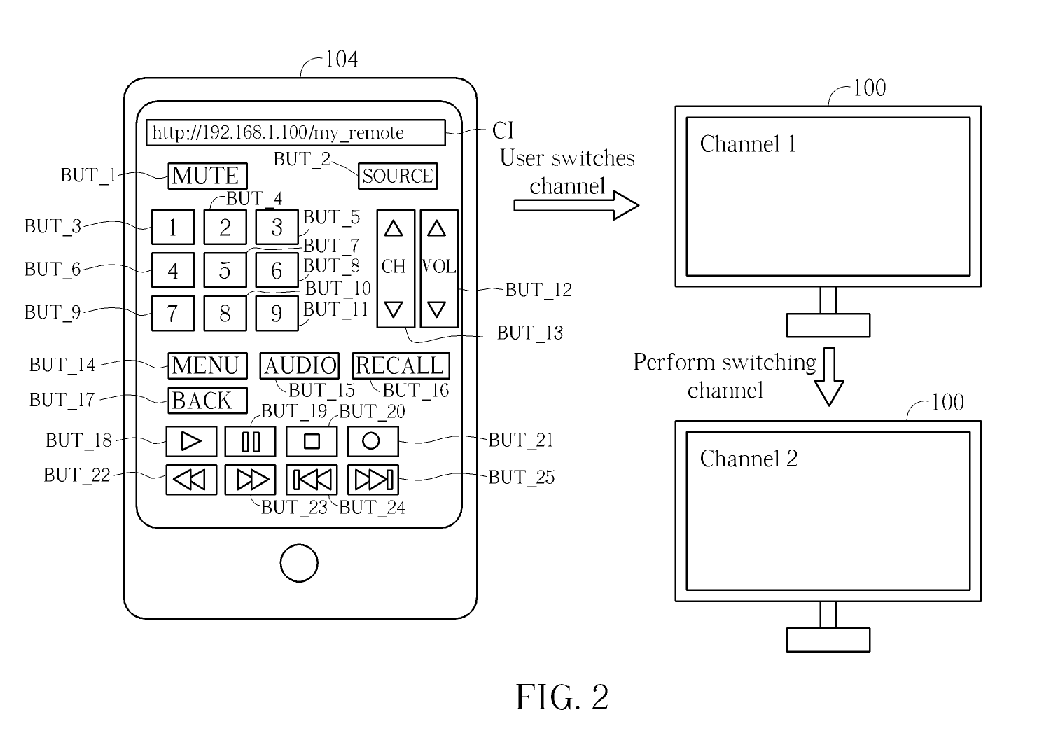

Please refer to FIG. 2, which is schematic diagram of an operation method of the multimedia playback system 10 shown in FIG. 1. In this embodiment, the control interface CI is a webpage constructed by a webpage language. When the user wants to use the handheld device 104 to control the multimedia device 100, the user inputs a Uniform Resource Locator (URL) of the control interface CI for sending a request REQ to the server 102. For example, the user may input the URL of the control interface CI in a browser of the handheld device 104 for sending the request REQ to the server 102. After receiving the request REQ sent by the handheld device 104, the server 102 accesses the control interface CI from the multimedia device 100 according to the request REQ and stores the control interface CI temporarily. The server 102 then transmits the control interface CI to the handheld device 104 according to the network protocol. As shown in FIG. 2, the control interface CI comprises buttons BUT_1-BUT_25 corresponding to a plurality of functions of the multimedia device 100, such as adjusting volume and switching a channel displayed by the multimedia device 100. When the user wants to control the multimedia device 100 to switch the channel, the user selects the button BUT_12 corresponding to the function of switching the channel via touch interactive or cursor clicking, so as to generates the instruction signal IS for instructing to switch channels. After receiving the instruction signal IS, the server 102 analyzes the instruction signal IS and generates the control signal CON according to the instruction signal IS. The multimedia device 100 switches the displayed channel from a channel 1 to a channel 2 according to the control signal CON, accordingly.

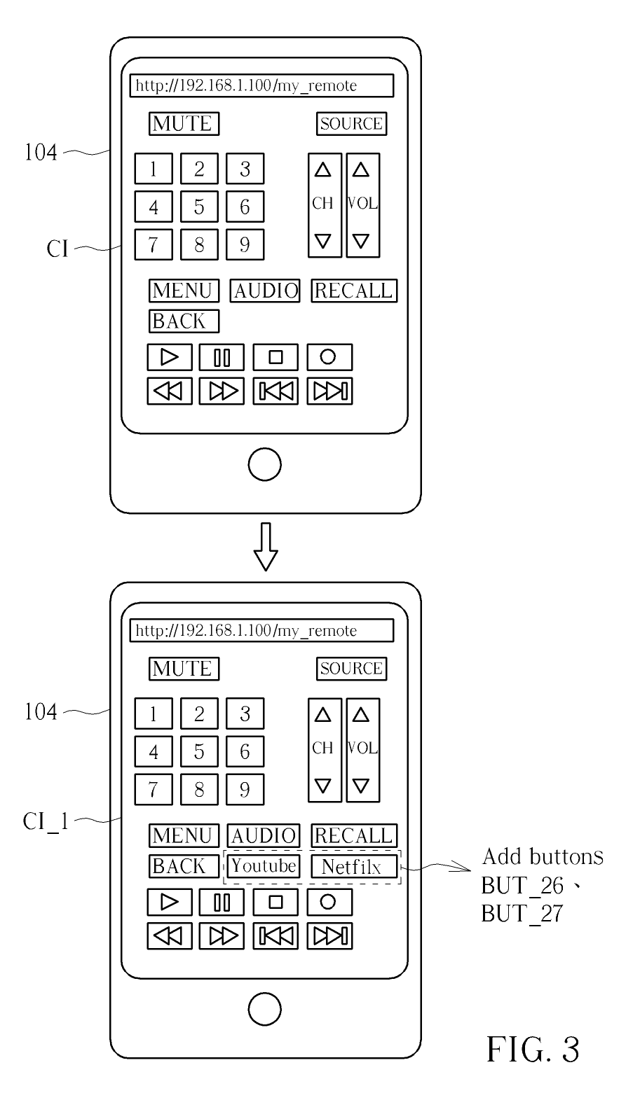

Please refer to FIG. 3, which is a schematic diagram of another operation method of the multimedia playback system 10. When the functions of the multimedia device 100 are updated via the network or the manual update, the multimedia device 100 can directly add buttons corresponding to new functions in the control interface CI stored in the server 102. As shown in FIG. 3, after the multimedia device 100 is updated, a YOUTUBE function and a Netflix function are increased in the multimedia device 100 and buttons BUTBUT_26, BUTBUT_27 corresponding to these two newly added functions are added in the control interface CIBUT_1. The user can therefore easily control the multimedia device 100 to perform the new functions via selecting the buttons BUTBUT_26, BUTBUT_27.

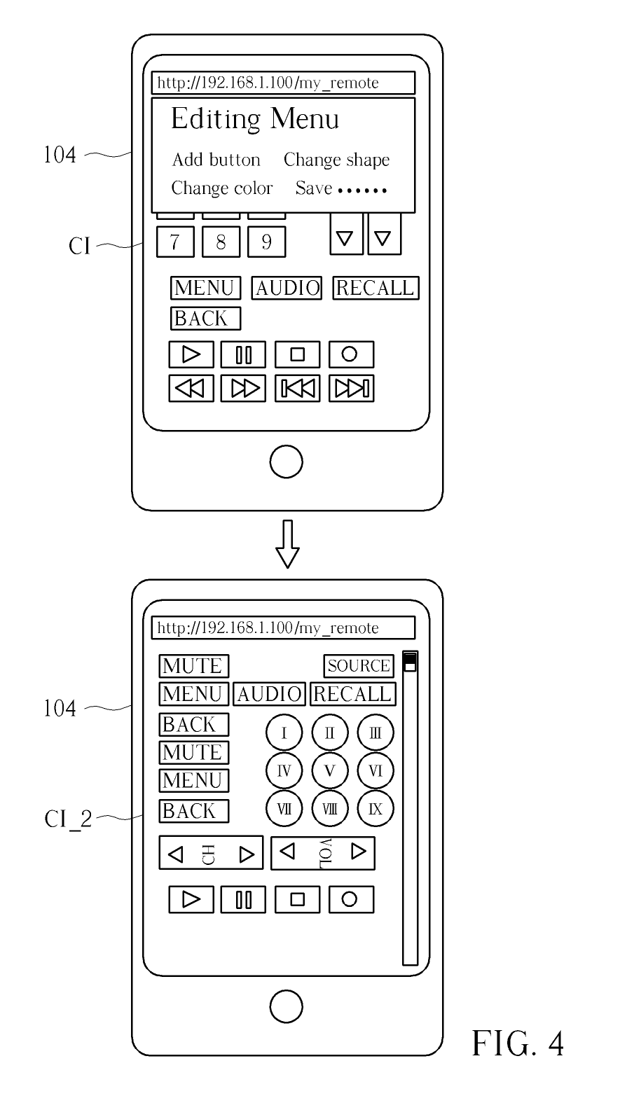

Please refer to FIG. 4, which is a schematic diagram of still another operation method of the multimedia playback system 10. In FIG. 4, the control interface CI comprises editing buttons SBBUT_1-SBBUT_5 utilized for editing the control interface CI. Via selecting the editing buttons SBBUT_1-SBBUT_5, the user can adjust the control interface CI to a control interface CIBUT_2 according to the habits of the user.

As shown in FIG. 4, the user may perform editing operations such as adjusting the shape of buttons, changing background color, editing symbols, changing button layout and adding/deleting the buttons. After the user finishes editing, the user uploads the control interface CIBUT_2 to the server 102 via the handheld device 104, to replace the control interface CI. As a result, the user can configure the layout of the control interface utilized for controlling the multimedia device 100 and is not limited to use the control interface CI stored in the server 102.

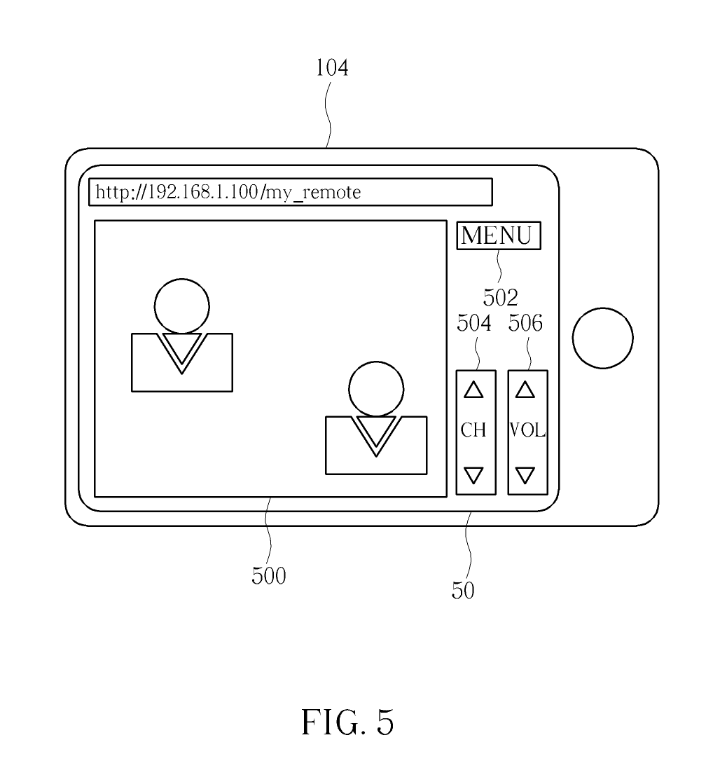

The control interface CI can also comprise the functions that the conventional touchtone remote controller is not equipped with. Please refer to FIG. 1 and FIG. 5, wherein FIG. 5 is a schematic diagram of a control interface 50 according to an embodiment of the present disclosure. In FIG. 5, the control interface 50 displayed by the handheld device 104 comprises a video window 500 and buttons 502-506. The handheld device 104 may acquire a video signal received by the multimedia device 100 from the server 102 via digital streaming. In such a condition, the user can watch the video signal received by the multimedia device 100 at the place where the electrical connection (i.e. wire connection or wireless connection) between the handheld device 104 and the server 102 can be maintained. Please note that the handheld device 104 can also be electrically connected to the multimedia device 100 and directly acquire the video signal from the multimedia device 100.

By storing the control interface for controlling the multimedia device in the server, the above embodiments allow the user to access the control interface through the handheld device and to control the multimedia device to perform specific functions though the server. Since the control interface can be realized by the webpage, the multimedia device can adaptively change the control interface by directly replacing the control interface when the multimedia device is updated. Moreover, the user can also change the layout of the control interface according to the habits of the user, so as to acquire a satisfying user experience. According to different applications, those with ordinary skill in the art may perform appropriate alternations and modifications. For example, the server 102 shown in FIG. 1 can be configured in the multimedia device 100 for improving the operation speed of the multimedia playback system 10. The instruction signal IS generated by the handheld device 104 may comprise a voice signal VS. After the server 102 analyzes the voice signal VS, the server 102 transmits the analysis result to the handheld device 104. Next, the handheld device 104 generates the instruction signal IS according to the analysis result, so as to control the multimedia device 100 through the server 102. Please note that the server 102 can also generate the control signal CON according to the analysis result, to achieve the goal of controlling the multimedia device 100.

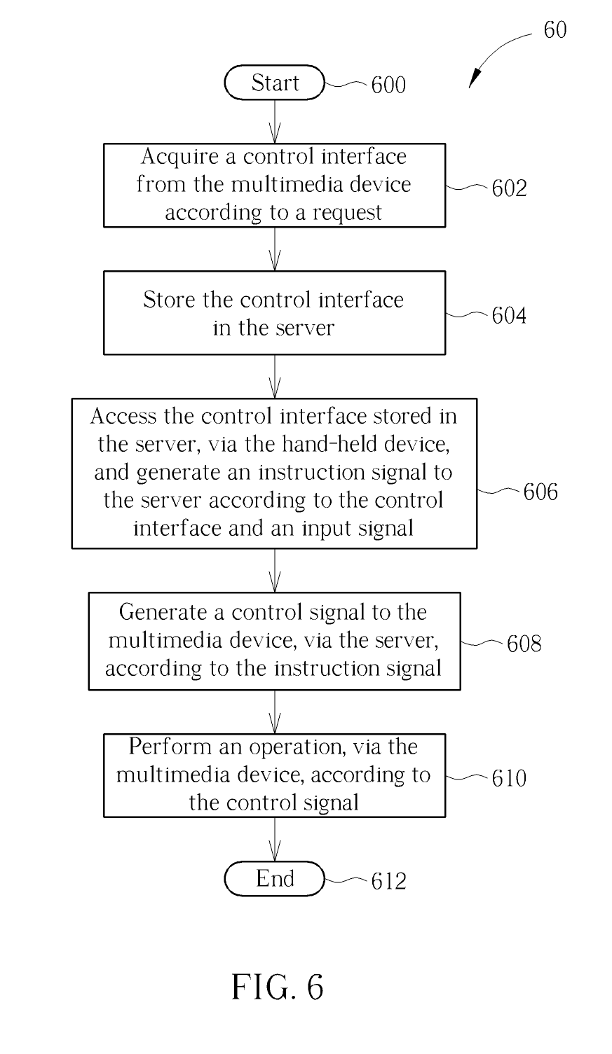

The operation method of the multimedia playback system 10 can be summarized by a control method 60. As shown in FIG. 6, the control method 60 comprises the following steps:

Step 600: Start.

Step 602: Acquire a control interface from the multimedia device according to a request.

Step 604: Store the control interface in the server.

Step 606: Access the control interface stored in the server, via the hand-held device, and generate an instruction signal to the server according to the control interface and an input signal.

Step 608: Generate a control signal to the multimedia device, via the server, according to the instruction signal.

Step 610: Perform an operation, via the multimedia device, according to the control signal.

Step 612: End.

According to the control method 60, the user uses the handheld device to achieve the goal of controlling the multimedia device via accessing the control interface stored in the server. Since the control interface can be realized by the webpage, the multimedia device can adaptively change the control interface by directly replacing the control interface when the multimedia device is updated. Moreover, the user can also change the layout of the control interface according to the habits of the user, so as to acquire a satisfying user experience.

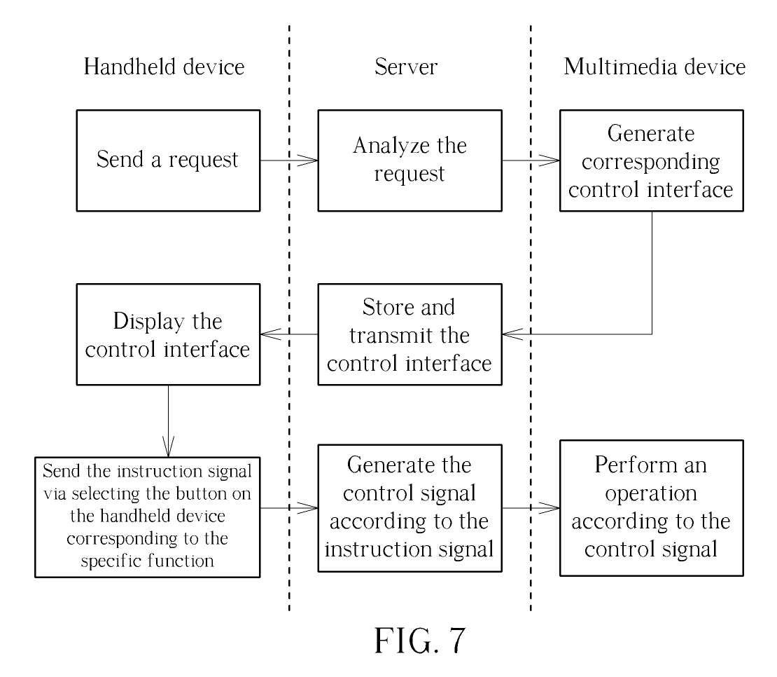

Please refer to FIG. 7, which is a schematic diagram of an operation method of the control method 60 shown in FIG. 6. When the user wants to control the multimedia device via the handheld device, the user sends a request to the server via the handheld device. For example, the handheld device may use a network protocol to send the request to the server via a browser. When receiving the request transmitted by the handheld device, the server analyzes the requests and transmits an analysis result to the multimedia device. The multimedia device generates the control interface according to the analysis result to the server. The control interface may comprise a plurality of buttons corresponding to a plurality of functions of the multimedia device. When the user wants to control the multimedia device to perform a specific function, the user selects the button corresponding to the specific function via touch interaction or cursor clicking and the handheld device generates the instruction signal according to the selected button (steps 602-606). After receiving the instruction signal, the server analyzes the instruction signal and generates the corresponding control signal to the multimedia device, to control the multimedia device to perform the specific function (steps 608, 610).

To sum up, the multimedia playback system and control method thereof disclosed in the above embodiments achieve the goal of controlling the multimedia device via using the handheld device to access the control interface of the multimedia device stored in the server. As a result, the multimedia device can directly add buttons corresponding to new functions in the control interface through replacing the control interface stored in the server. Moreover, the user can also adjust the layout of the control interface according to the habits of the user. The user can thereby acquire an excellent user experience.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A multimedia playback system, comprising:
a multimedia device, for generating a control interface according to a request and performing an operation according to a control signal;
a server, coupled to the multimedia device, for storing the control interface generated by the multimedia device and generating the control signal according to an instruction signal; and
a hand-held device, coupled to the server, for accessing the control interface stored in the server and generating the instruction signal according to the control interface and an input signal.

2. The multimedia playback system of claim 1, wherein the server is configured in the multimedia device.

3. The multimedia playback system of claim 1, wherein the control interface comprises a webpage.

4. The multimedia playback system of claim 1, wherein the hand-held device accesses the control interface via an internet protocol.

5. The multimedia playback system of claim 1, wherein the input signal comprises a voice signal.

6. The multimedia playback system of claim 1, wherein the multimedia device is a television.

7. A control method for a multimedia playback system, the multimedia playback system comprising a multimedia device, a server and a hand-held device, and the control method comprising:
acquiring a control interface from the multimedia device according to a request;
storing the control interface in the server;
accessing the control interface stored in the sever via the hand-held device, and generating an instruction signal to the server according to the control interface and an input signal;
generating a control signal to the multimedia device via the server according to the instruction signal; and
performing an operation via the multimedia device according to the control signal.

8. The control method of claim 7, wherein the server is configured in the multimedia device.

9. The control method of claim 7, wherein the control interface comprises a webpage.

10. The control method of claim 7, wherein the hand-held device accesses the control interface via an internet protocol.

11. The control method of claim 7, wherein the input signal comprises a voice signal.

12. The control method of claim 7, wherein the multimedia device is a television.
